(19) United States
(12) Patent Application Publication
(10) Pub. No.: US 2008/0022804 A1
(43) Pub. Date: Jan. 31, 2008

(54) Adjustable Set of Pedals for a Motor Vehicle

(75) Inventor: Giovanni Stefani, Sassuolo (IT)

Correspondence Address: OBLON, SPIVAK, MCCLELLAND MAIER & NEUSTADT, P.C., 1940 DUKE STREET, ALEXANDRIA, VA, 22314, US

(73) Assignee: Ferrari S.P.A., Modena (IT)

(21) Appl. No.: 10/583,550

(22) PCT Filed: Dec. 15, 2004
(86) PCT No.: PCT/IB04/04195

§ 371 Date: May 21, 2007

(30) Foreign Application Priority Data
Dec. 19, 2003 (IT) BO2003A 000763

(51) Int. Cl. B60T 7/06; G05G 1/14

(52) U.S. Cl. 74/512; 180/334; 74/522; 74/560

(57) ABSTRACT

An adjustable set of pedals for a motor vehicle provided with at least two pedals for acceleration and, respectively, braking of the motor vehicle, which are mounted on a supporting element. A position of the supporting with respect to a fixed frame of the motor vehicle is controlled selectively by a regulation device defined by a crank mechanism set between the supporting element and the frame itself.

### TECHNICAL FIELD

The present invention relates to an adjustable set of pedals for a motor vehicle.

### BACKGROUND ART

Motor vehicles currently on the market are provided with a driving position comprising a driving seat, a steering wheel, a set of pedals, and a dashboard. Since the physical characteristics of the person or persons that will drive the motor vehicle are not known a priori, it is necessary to provide a series of adjusting devices, which enable the positions of the various components of the driving position to be varied with respect to one another so as to adapt the proportions of the driving position to the physical characteristics of the driver. In the majority of motor vehicles available on the market, the set of pedals and the dashboard are arranged in fixed positions, the steering wheel is generally height-adjustable, and the seat is adjustable both as regards the height and as regards its distance from the steering wheel.

The solution that envisages maintaining the dashboard, set of pedals, and steering wheel substantially fixed and pushing the seat forwards and backwards is simple and inexpensive to produce and is hence used in the vast majority of motor vehicles. However, this solution also presents some drawbacks in so far as is it is impossible to provide a geometry of the dashboard that will enable its instrumentation to be properly visible in every seat position.

Furthermore, the solution just described entails the construction of a driving position that is relatively extensive in length so as to obtain a sufficiently long travel of the seat. Said requisite is fully acceptable in a motor vehicle with four or more seats, i.e., in a motor vehicle that is also provided with rear seats, but can prove problematical in a two-seater motor vehicle, i.e., in a motor vehicle without rear seats, which has an overall length of the passenger compartment that is relatively small.

To overcome the drawbacks described above solutions have been proposed in which the driving seat is fixed and the set of pedals and the steering wheel are mobile with respect to the seat so as to vary their distance from the seat.

In particular, many solutions have been proposed to provide an adjustable set of pedals for a motor vehicle. However, the known solutions present various drawbacks in so far as they have a very short stroke of adjustment, are complex, and are difficult to produce.

### DISCLOSURE OF INVENTION

The purpose of the present invention is to provide an adjustable set of pedals for a motor vehicle that will be free from the drawbacks described above and will be simple and inexpensive to produce.

According to the present invention an adjustable set of pedals for a motor vehicle is provided as claimed in Claim 1.

### BRIEF DESCRIPTION OF THE DRAWINGS

The present invention will now be described with reference to the annexed plate of drawings, which illustrate a non-limiting example of embodiment thereof, in which:

FIG. 1 is a schematic perspective view of a preferred embodiment of the adjustable set of pedals according to the present invention;

FIGS. 2 and 3 are two side views of the adjustable set of pedals of FIG. 1, illustrated in two different operative positions;

FIG. 4 is a longitudinal sectional view of a first detail of FIG. 1, illustrated in two different operative positions; and

FIG. 5 is a longitudinal sectional view of a second detail of FIG. 1, illustrated in two different operative positions.

### BEST MODE FOR CARRYING OUT THE INVENTION

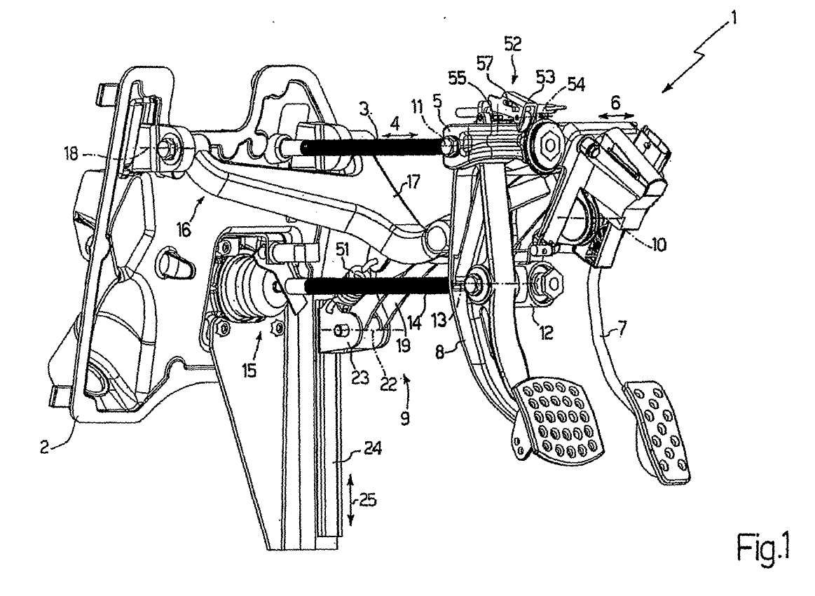

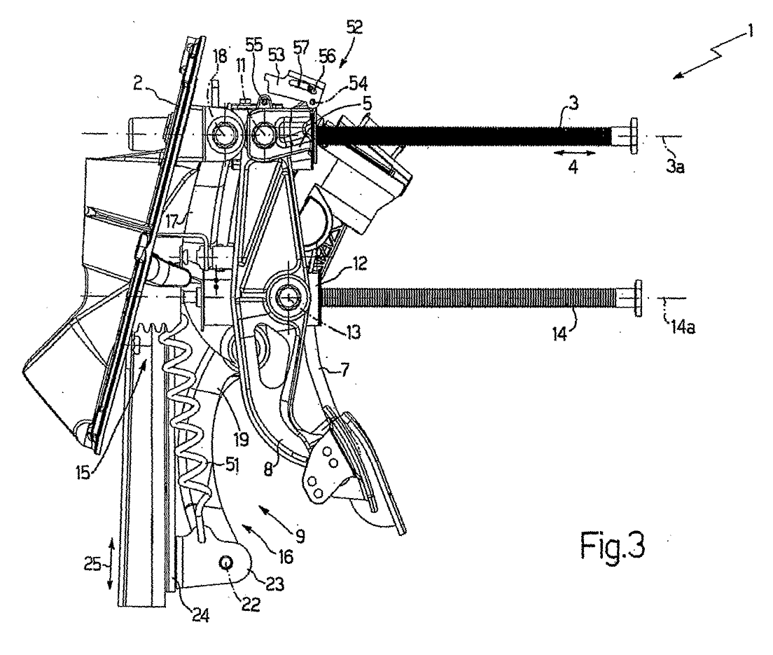

With reference to FIGS. 1, 2, and 3, designated as a whole by 1 is an adjustable set of pedals for a motor vehicle (not illustrated).

The set of pedals 1 comprises a fixing plate 2, which enables anchorage of the set of pedals 1 itself to a fixed frame (not illustrated) of the motor vehicle (not illustrated), and supports a toothed guide rod 3, which projects from the plate 2 in a given direction 4, has a longitudinal axis 3a, and is provided with a toothing having, in longitudinal sectional view, a substantially V-shape.

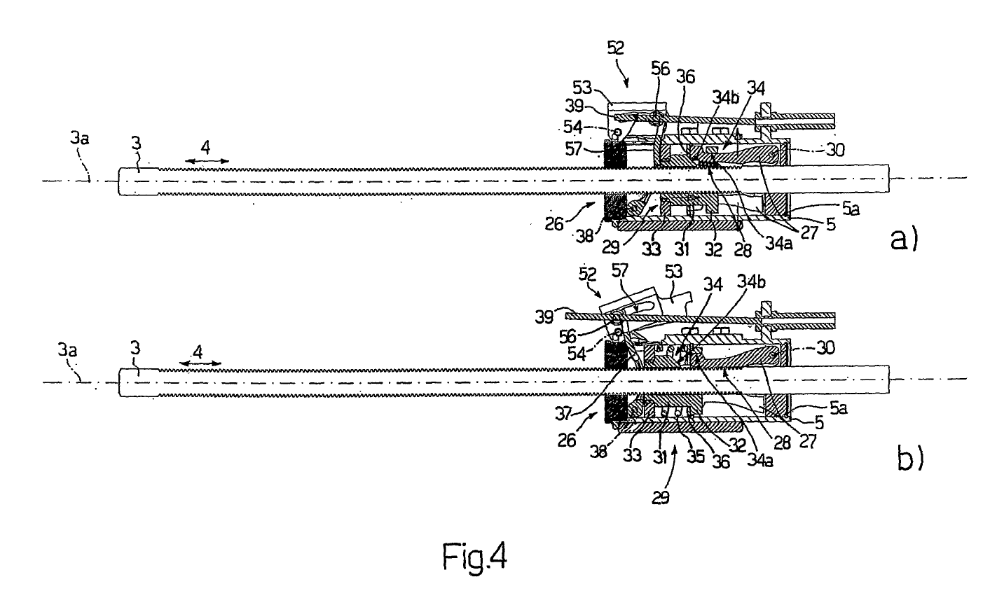

The rod 3 is slidably engaged by a slide 5, which extends in a direction 6 substantially transverse to the direction 4, has a central hole 5a (FIG. 4) made through the slide 5 and set so that it shares the axis 3a of the rod 3, supports, in the case in point, two pedals 7, 8 for acceleration and, respectively, braking of the motor vehicle (not illustrated), and is mobile along the rod 3 itself under the action of the thrust of an actuating device 9 that will be illustrated in greater detail in what follows.

According to a variant (not illustrated), the slide 5 further supports a clutch pedal of the motor vehicle (not illustrated).

The pedal 7 is a pedal of a known type, mounted on the slide 5 for oscillating, with respect to the slide 5 itself, about an axis 10 of fulcrum substantially parallel to the direction 6, and the pedal 8 is hinged, in a position corresponding to a free end of its own, to the slide 5 for oscillating, with respect to the slide 5 itself, about an axis 11 of fulcrum substantially parallel to the axis 10.

The pedal 8 is hinged, moreover, in a position corresponding to an intermediate point thereof, to a sleeve 12 for oscillating, with respect to the sleeve 12 itself, about an axis 13 of fulcrum substantially parallel to the axis 11.

The sleeve 12 is mounted coaxially to a toothed rod 14, which has a longitudinal axis 14a parallel to the axis 3a, and is provided with a toothing having, in longitudinal sectional view, a substantially saw-toothed shape. The sleeve 12 is coupled in an axially slidable manner to the rod 14 to perform, along the rod 14 itself and under the action of the thrust of the device 9, rectilinear displacements in the direction 4, and is connectable (according to modalities that will be described in greater detail in what follows) to the rod 14 to impart on the rod 14 itself, following upon oscillation of the pedal 8 about the axis 11, rectilinear displacements in the direction 4 so as to control selectively operation of a braking device 15 of a known type.

The actuating device 9 comprises a crank mechanism 16 comprising, in turn, a crank 17, hinged to the plate 2 for oscillating, with respect to the plate 2 itself, about an axis 18 of fulcrum substantially parallel to the direction 6, and a connecting rod 19, which is hinged, in a position corresponding to an intermediate point thereof, to one free end of the crank 17 for oscillating, with respect to the crank 17 itself, about an axis 20 of fulcrum parallel to the axis 18, and extends between two axes 21, 22 parallel to the axis 20, and of which the axis 21 is the axis of rotation of the connecting rod 19 with respect to the slide 5, and the axis 22 is the axis of rotation of the connecting rod 19 with respect to a pad 23 coupled slidably to a rectilinear guide 24 extending in a direction 25 orthogonal to the directions 4 and 6.

According to what is illustrated in FIG. 4, the device 9 further comprises a clamping device 26, which enables blocking of the slide 5 along the rod 3, and comprises a plurality of gripping arms 27 (in the case in point, three arms 27), which are mounted within the hole 5a, are uniformly distributed around the rod 3 and hence around the axis 3a, and have respective toothed portions 28 set in a position facing the rod 3 itself.

The arms 27 are hinged to the slide 5 for oscillating, with respect to the slide 5 itself and under the action of the thrust of an actuator device 29, about respective axes 30 of fulcrum transverse to the axis 3a itself between a position of clamping (FIG. 4b), in which the arms 27 set themselves at a distance from one another approximating by defect the diameter of the rod 3 so as to enable the portions 28 to engage the rod 3 itself, and a position of release (FIG. 4a), in which the arms 27 set themselves at a distance from one another approximating by excess the diameter of the rod 3 so as to enable the portions 28 to disengage the rod 3 itself.

The device 29 comprises a mechanically actuated tubular piston 31, which is mounted, within the hole 5a, so that it shares the axis 3a of the rod 3, is coupled slidably to the rod 3, and is provided, in a position corresponding to a first free end of its own, with an annular flange 32 extending radially outwards from the outer surface of the piston 31, and, in a position corresponding to a second free end of its own, with a cup 33 fixed to the piston 31 itself perpendicular to the axis 3a.

The piston 31 has a plurality of races 34, which are uniformly distributed about the axis 3a, are equal in number to the arms 27, are slidably engaged, each, by a respective arm 27, and comprise, each, a respective first stretch 34a made through the flange 32 parallel to the axis 3a and a respective second stretch 34b made through the piston 31 and inclined with respect to the axis 3a itself.

The device 29 further comprises a spring 35, which is mounted within the hole 5a so that it shares the axis 3a of the rod 3, and is set between the cup 33 and an annular element 36 fixed within the hole 5a for displacing the piston 31 into, and normally maintaining it in, a resting position (FIG. 4b), in which the free ends of the arms 27 engage the corresponding stretches 34a and the portions 28 set themselves on the outside of the corresponding races 34 to engage the rod 3.

The piston 31 is mobile, under the action of the thrust of a lever 37, hinged within the hole 5a for oscillating about an axis 38 of fulcrum transverse to the axis 3a and against the thrust of the spring 35, from the aforesaid resting position to an operative position (FIG. 4a), in which the free ends of the arms 27 engage the corresponding stretches 34b and the portions 28 engage the corresponding stretches 34a to disengage the rod 3.

The lever 37 projects radially outwards from the slide 5 to be actuated by a cable 39 of a Bowden type designed to displace the lever 37 itself about the axis 38.

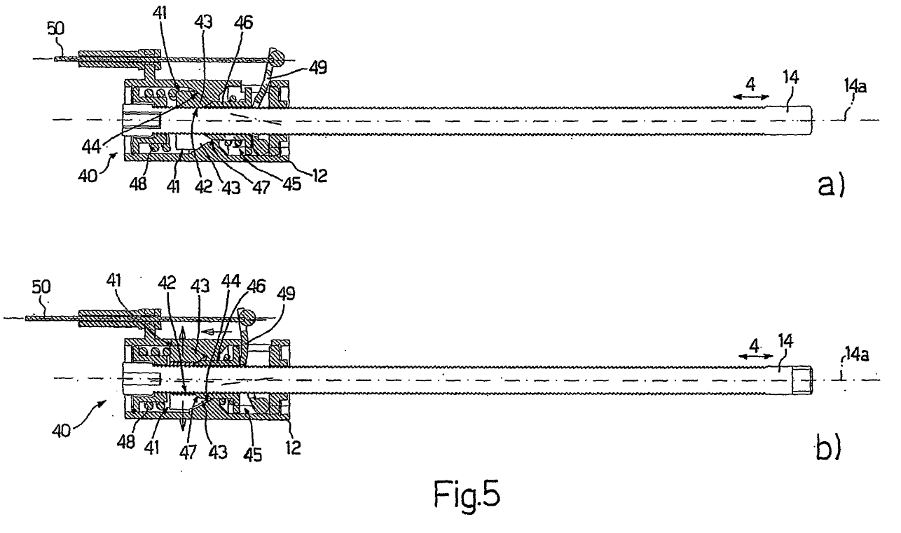

With reference to FIG. 5, the device 9 further comprises a clamping device 40, which enables blocking of the sleeve 12 along the rod 14 and comprises a plurality of gripping members 41 (in the case in point, three members 41), which are mounted within the sleeve 12, and are uniformly distributed around the rod 14. Each member 41 is limited radially by a toothed face 42, which extends parallel to the axis 14a and is set in a position facing the rod 14, and is limited axially by a substantially wedge-shaped portion 43 set in engagement with a race 44 shaped like a truncated cone made on the internal surface of the sleeve 12 and normally common to all the members 41.

The members 41 are mobile, under the action of the thrust of an actuator device 45, between a position of clamping (FIG. 5a), in which the members 41 set themselves at a distance from one another approximating by defect the diameter of the rod 14 so as to enable the faces 42 to engage the rod 14 itself, and a position of release (FIG. 5b), in which the members 41 set themselves at a distance from one another, approximating by excess the diameter of the rod 14 so as to enable the faces 42 to disengage the rod 14 itself.

The device 45 comprises: a mechanically actuated tubular piston 46, which is mounted within the sleeve 12 so that it shares the axis 14a of the rod 14, is coupled slidably to the rod 14, and is limited axially by a surface 47 substantially shaped like a truncated cone, set in engagement with the portions 43; and a spring 48, which is fitted on the rod 14 so that it shares the axis 14a of the rod 14 and is set between the sleeve 12 and the members 41 for displacing the members 41 themselves into, and normally maintaining them in, their clamping position, and for displacing the piston 46 into, and normally maintaining it in, a resting position (FIG. 5a).

The piston 46 is mobile, under the action of the thrust of a lever 49, which extends through the sleeve 12 to be actuated by a cable 50 of a Bowden type, and against the thrust of the spring 48, from the aforesaid resting position to an operative position (FIG. 5b), in which the members 41 are displaced along the race 44 and into their position of release.

In connection with what is set forth above, it should moreover be pointed out that:

the cable 50 is normally connected to the cable 39 to enable the driver of the motor vehicle (not illustrated) to actuate the devices 26 and 40 with a single operation; and

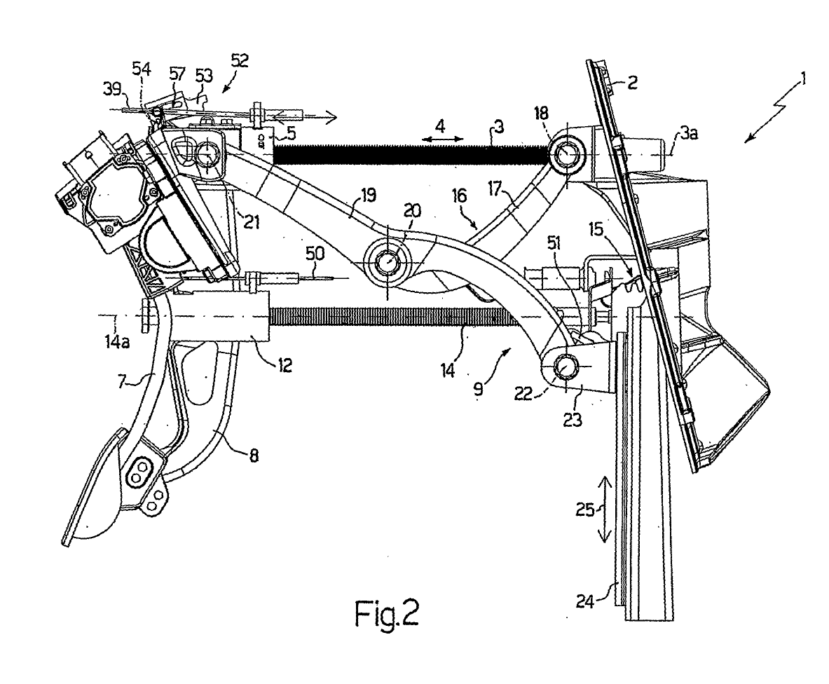

when the devices 26 and 40 are displaced into their positions of release, the crank mechanism 16 is displaced into, and normally kept, in an operative position (see FIGS. 1 and 2), in which the slide 5 and hence the pedals 7, 8 are set at the maximum distance from the plate 2, by a spring 51 set between the crank 17 and the pad 23.

Finally, the device 9 comprises a device 52 for clamping the pedal 8 about the axis 11, which in turn comprises a crank 53, which is hinged to the slide 5 for oscillating, with respect to the slide 5 itself, about an axis 54 of fulcrum parallel to the direction 6, and is mobile between a position of clamping (FIG. 4a), in which the crank 53 engages a pin 55 projecting from the pedal 8 parallel to the direction 6 itself, and a position of release (FIGS. 1 and 4b) . The crank 53 is actuated by the cable 39 via a pin 56, which is fixed to the cable 39 itself, extends parallel to the direction 6, and is mobile along a groove 57 made in the crank 53 so as to displace the device 52 into its clamping position, before displacing the devices 26 and 40 into their positions of release, and into its position of release, after displacing the devices 26 and 40 into their clamping positions.

According to a variant (not illustrated), the device 26 is replaced with a clamping device designed to control selectively the position of the crank 17 about the axis 18.

According to a further variant (not illustrated), the rods 3 and 14 are replaced with two threaded rods, which are set in rotation by respective electric motors or, alternatively, by a single motor common to both of the threaded rods, and are coupled to the slide 5 and to the sleeve 12 via respective external-thread/internal-thread couplings.

In use, the driver of the motor vehicle actuates the cables 39 and 50 so as to displace, in the first place, the device 52 into its clamping position and prevent oscillation of the pedal 8 about the axis 11 and then displace the devices 26 and 40 into their positions of release. At this point, the crank mechanism 16 is displaced by the spring 51 into its operative position illustrated in FIGS. 1 and 2, the set of pedals 1 is displaced in the direction 4 by the driver via the engagement of the pedal 8, and, finally, once the desired position along the rod 3 has been reached, the cables 39 and 50 are released by the driver himself to enable, in the first place, the devices 26 and 40 to be set in their clamping positions and hence the device 52 to be set in its position of release.

The set of pedals 1 presents a number of advantages chiefly deriving from the fact that the slide 5, and hence the axes 10, 11 of fulcrum of the pedal 7 and, respectively, of the pedal 8, are displaced along a rectilinear path parallel to the direction 4, and from the fact that the crank mechanism 16 enables, in a simple and inexpensive way, relatively extensive displacements of the slide 5 in the direction 4.

1-17. (canceled)

18. An adjustable set of pedals for a motor vehicle, comprising:
a first pedal for braking of the motor vehicle;
a second pedal for acceleration of the motor vehicle;
means for supporting the first and second pedals; and
an adjustment device for controlling selectively the position of the supporting means with respect to a frame of the motor vehicle and comprising a crank mechanism set between the supporting means and the frame;
the adjustment device comprising:
a first guide extending in a first direction and supporting the supporting means which are mobile along the first guide; and
a control rod parallel to the first direction, slidably engaged through the first pedal, and connectable with the first pedal for actuating a braking device of the motor vehicle.

19. The adjustable set of pedals according to claim 18, wherein the first guide comprises a first screw mounted to rotate about a first longitudinal axis; the supporting means being coupled to the first screw via a first external-thread/internal-thread coupling.

20. The adjustable set of pedals according to claim 18, wherein the adjustment device further comprises:
a second guide extending in a second direction substantially transverse to the first direction; and
a slide, mounted to slide along the second guide under action of thrust of the crank mechanism.

21. The adjustable set of pedals according to claim 20, wherein the crank mechanism comprises:
a connecting rod set between the supporting means and the slide; and
a crank set between the frame and the connecting rod.

22. The adjustable set of pedals according to claim 20, wherein the supporting means is mobile under action of thrust of the crank mechanism between a first end position and a second end position; and thrust means are provided for displacing the supporting means into, and normally maintaining the supporting means in, one of the first and second end positions.

23. The adjustable set of pedals according to claim 22, wherein the thrust means include elastic thrust means set between the slide and the crank mechanism.

24. The adjustable set of pedals according to claim 18, wherein the adjustment device further comprises:
first clamping means for blocking the supporting means along the first guide; and
a first actuator device for actuating the first clamping means between a first position of clamping of the supporting means along the first guide and a first position of release.

25. The adjustable set of pedals according to claim 24, wherein the first clamping means comprises a plurality of first clamping members carried by the supporting means, distributed around the first guide, and mobile away from and towards the first guide, and the first actuator device comprises first actuator means for displacing the first clamping members from the first position of clamping to the first position of release, and second actuator means for displacing the first clamping members from the first position of release to the first clamping position.

26. The adjustable set of pedals according to claim 24 further comprising:
second clamping means for blocking the first pedal along the control rod; and
a second actuator device to actuate the second clamping means between a second position of clamping of the first pedal along the control rod and a second position of release.

27. The adjustable set of pedals according to claim 26, wherein the second clamping means comprises a plurality of second clamping members carried by the first pedal, distributed around the control rod, and mobile away from and towards the control rod, and the second actuator device comprises third actuator means for displacing the second clamping members from the second position of clamping to the second position of release, and fourth actuator means for displacing the second clamping members from the second position of release to the second clamping position.

28. The adjustable set of pedals according to claim 26, wherein the first pedal is rotatably mounted on the supporting means for oscillating about a second axis of fulcrum; third clamping means are provided for blocking angularly the first pedal about the axis of fulcrum; and a third actuator device is configured to actuate the third clamping means between a third position of clamping of the first pedal about the second axis of fulcrum and a third position of release.

29. The adjustable set of pedals according to claim 28, wherein the first, second, and third actuator devices are connected together for displacing the third clamping means into the corresponding clamping position, when the first and the second clamping means are displaced into their corresponding positions of release, and into the corresponding position of release when the first and the second clamping means are displaced into their corresponding clamping positions.

30. The adjustable set of pedals according to claim 18, wherein the first direction is a substantially rectilinear direction.

31. The adjustable set of pedals according to claim 18, wherein the first pedal is coupled to the control rod via a second external-thread/internal-thread coupling.

32. The adjustable set of pedals according to claim 18, wherein the first pedal is hinged to the supporting means for oscillating about a second axis of fulcrum, and the second pedal is hinged to the supporting means for oscillating, with respect to the supporting means, about a fourth axis of fulcrum parallel to the second axis of fulcrum.

33. The adjustable set of pedals according to claim 32, wherein the first pedal is further hinged in a position corresponding to an intermediate point thereof, to a sleeve slidable along the control rod for oscillating, with respect to the sleeve, about a fifth axis of fulcrum substantially parallel to the second axis of fulcrum.

34. The adjustable set of pedals according to claim 33, wherein the sleeve is coupled in an axially slidable manner to the control rod to perform rectilinear displacements along the control rod, and is connectable to the control rod to impart on the control rod, following upon oscillation of the first pedal about the second axis of fulcrum, rectilinear displacements so as to control selectively operation of a braking device.
